(19) United States
(12) Patent Application Publication
(10) Pub. No.: US 2008/0250201 A1
(43) Pub. Date: Oct. 9, 2008

(54) Information processing system and control method thereof

(75) Inventors: Akihiro Mori, Odawara (JP); Kunihiko Nashimoto, Odawara (JP)

Correspondence Address: Stanley P. Fisher;Reed Smith LLP, Suite 1400, 3110 Fairview Park Drive, Falls Churhc, VA, 22042-4503, US

(73) Assignee: HITACHI, LTD.

(21) Appl. No.: 12/155,717

(22) Filed: Jun. 9, 2008

Related U.S. Application Data
(63) Continuation of application No. 10/921,170, filed on Aug. 19, 2004.

(30) Foreign Application Priority Data
Jun. 25, 2004 (JP) 2004-187775

(51) Int. Cl. G06F 12/08

(52) U.S. Cl. 711/113; 711/E12.019

(57) ABSTRACT

A control technique for resident information or release of resident information in a cache memory is provided, by which residence is set into a cache memory without regard of a logical volume where a dataset is present, and an unused resident area in the cache memory is automatically deleted. In an information processing system, a host system has a resident management program for automatically acquiring a logical volume name from a dataset name specified by the user with reference to catalog information for managing dataset stored in the logical volume and instructing the dataset on the logical volume having the corresponding logical volume name to be resident. Further, a disk array system has microprogram for making the dataset on the logical volume having the corresponding logical volume name resident in the cache memory in response to the instruction to set residence from the resident management program.

### CROSS-REFERENCE TO RELATED APPLICATION

This application is a Continuation of U.S. patent application Ser. No. 10/921,170, filed Aug. 19, 2004. Priority is claimed based on U.S. patent application Ser. No. 10/921,170, filed Aug. 19, 2004, which claims priority from Japanese Patent Application No. JP 2004-187775 filed on Jun. 25, 2004, the content of which is hereby incorporated by reference into this application.

### TECHNICAL FIELD OF THE INVENTION

The present invention relates to a cache memory controlling technique for an external storage device having the cache memory, and more particularly, it relates to the technique effectively applied to the control of the resident information or release of the resident information in a cache memory.

### BACKGROUND OF THE INVENTION

According to the examination by the inventors of the present invention, the following technique is known as the cache memory controlling technique for an external storage device having the cache memory.

For example, in the information processing systems including an external storage device and the like, with the development of its performance and the increase of its scale, the demand for the higher performance of the external storage device has been increasing in recent years. Particularly in the external storage devices, efficient control methods for large-capacity cache memories are becoming more and more important. For this reason, a system relative to the control of such large-capacity cache memories is suggested as follows.

Japanese Patent Application Laid-Open No. 2002-132552 discloses an information processing system in which the unit of specification to set and release residence in a cache memory is not limited to the dataset name, and the specification of the physical position, the specification of the volume inventory only, the specification of the volume name or dataset are possible. In this information processing system, the resident management program enables to set residence by issuing information of the physical position necessary to release residence to a disk array system. In the volume inventory/volume specification, the resident management program acquires physical information necessary to release residence from the volume inventory information in a volume in a disk drive. Also, the resident management program compares the resident management information with the information of the volume inventory so as to acquire a physical position necessary to release residence and then deletes an area remaining on the cache memory.

### SUMMARY OF THE INVENTION

Incidentally, as a result of the examination of the conventional cache memory controlling technique for an external storage device having the cache memory by the inventors of the present invention, the following is revealed.

For example, in the conventional information processing systems including an external storage device, a resident management program provides a function to set residence in the cache memory per dataset. This function acquires the information of the volume inventory based on a volume name specified by a user and searches a dataset name specified by the user to analyze the position information about the dataset. This position information is used to set residence in the cache memory.

Under the circumstance of such an information processing system, however, the dataset is moved to a volume whose frequency of use is low for the load balance. For this reason, even if the dataset is once resident in the cache memory, the user must specify the dataset to be resident again. At this time, it is necessary for the user to determine the volume to which the target dataset is moved. For example, in the technique of Japanese Patent Application Laid-Open No. 2002-132552, since it is essential to specify a volume name from the user, the user must find a volume where the target dataset is present when specifying the dataset to be resident.

Therefore, an object of the present invention is to provide a control technique of the resident information or release of the resident information in a cache memory which can set residence without regard of the user to a logical volume where a dataset is present and can automatically delete an unused resident area of the cache memory.

The above and other objects and novel characteristics of the present invention will be apparent from the description of the specification and the accompanying drawings.

The outline of the representative one of the inventions disclosed in this application will be simply described as follows.

The present invention is applied to an information processing system and a control method thereof, the information processing system including: an external storage device having a logical volume comprised of a plurality of physical disks for storing a dataset therein and a cache memory for temporarily storing a dataset to be written and read into/from the logical volume; and a host system which is connected to the external storage device and writes and reads the dataset into/from the external storage device, and the invention has the following characteristics.

That is to say, in the information processing system of the present invention, the host system has load management means for distributing the datasets to be stored in the logical volume to the logical volumes, management information for managing the dataset stored in the logical volume, and resident management means for automatically acquiring a logical volume name from a dataset name specified by a user with reference to the management information and instructing the dataset to be resident on the logical volume having the corresponding logical volume name. Further, the external storage device has control means for receiving the instruction to set residence from the resident management means so as to make the dataset on the logical volume having the corresponding logical volume name resident in the cache memory. Further, the management information is prepared as a management table for each dataset, in which the dataset name is related with the logical volume name.

Concretely, the resident management means has a function to acquire position information about the dataset from the volume inventory information on the logical volume to give it to a command when instructing the dataset on the logical volume having the corresponding logical volume name to be resident. Further, the position information about the dataset includes a start address and an end address expressed two-dimensionally by a cylinder address and a track address. Also, the load management means has a function to move the dataset resident in the cache memory from a logical volume whose frequency of use is high to a logical volume whose frequency of use is low.

Further, in the information processing system of the present invention, the resident management means has a function to automatically acquire a logical volume name of the dataset name specified by the user with reference to the management information and instruct the release of an unused resident area for the logical volume having the corresponding logical volume name. Further, the control means has a function to receive the instruction of the release of residence from the resident management means and delete the unused resident area for the logical volume having the corresponding logical volume name from the cache memory.

Concretely, the resident management means has a function to acquire volume inventory information on the logical volume and resident area information of the logical volume so as to determine a resident area where the dataset is not present according to a logical operation of the volume inventory information and the resident area information when instructing the release of the unused resident area for the logical volume having the corresponding logical volume name. Further, the resident management means has a function to store an executed operation log in a dedicated dataset so as to discriminate a target logical volume based on the dedicated dataset when recognizing the corresponding logical volume. Alternatively, the resident management means has a function to discriminate all logical volumes specified by the user as target logical volumes in advance when recognizing the corresponding logical volume name.

Further, in the information processing of the present invention, the resident management means has a function to instruct the dataset on the logical volume having the corresponding logical volume name to be resident after instructing the release of the unused resident area for the logical volume having the corresponding logical volume name. Further, the control means has a function to make the dataset on the logical volume having the corresponding logical volume name resident in the cache memory after deleting the unused resident area for the logical volume having the corresponding logical volume name from the cache memory.

The effect obtained by the representative one of the inventions disclosed in this application will be briefly described as follows.

According to the present invention, a user can set residence in the cache memory without regard to the logical volume where a dataset is present.

Further, according to the present invention, an unused resident area in the cache memory can be automatically deleted.

### BRIEF DESCRIPTION OF THE DRAWINGS

FIG. 1 is a diagram illustrating an entire configuration of an information processing system according to an embodiment of the present invention;

FIG. 2 is a diagram illustrating a cooperative configuration between residence in a cache memory and a load balance in the information processing system according to an embodiment of the present invention;

FIG. 3 is a diagram illustrating a configuration of catalog information in the information processing system according to an embodiment of the present invention;

FIG. 4 is a diagram illustrating a configuration of position information of a logical volume in the information processing system according to an embodiment of the present invention;

FIG. 5 is a diagram illustrating a configuration of volume inventory information in the information processing system according to an embodiment of the present invention;

FIG. 6 is a diagram illustrating a command processing sequence of an instruction to set residence to the cache memory in the information processing system according to an embodiment of the present invention;

FIG. 7 is a diagram illustrating a command format from a user in the information processing system according to an embodiment of the present invention;

FIG. 8A is a diagram illustrating an example of an instruction format to set and release residence from a user in the present invention in the information processing system according to an embodiment of the present invention;

FIG. 8B is a diagram illustrating an example of an instruction format to set and release residence from the user in the conventional technique in the information processing system according to an embodiment of the present invention; and

FIG. 9 is a diagram illustrating a format of a dataset in which the history is stored in the information processing system according to an embodiment of the present invention.

### DESCRIPTION OF THE PREFERRED EMBODIMENTS

An embodiment of the present invention will be described in detail with reference to the accompanying drawings. Note that components having the same function are denoted by the same reference symbols throughout the drawings for describing the embodiment, and the repetitive description thereof will be omitted.

### <Concept of Present Invention>

The present invention is applied to an information processing system includes a disk array system (external storage device) and a host system. The disk array system has a logical volume comprised of a plurality of physical disks for storing datasets therein and a cache memory for temporarily storing datasets for writing into and reading from the logical volume. The host system is connected to the disk array system to write into or read from the datasets.

In such a configuration of the information processing system, the host system has a load management program (load management means), catalog information (management information), and a resident management program (resident management means). The load management program distributes the datasets stored in one logical volume to another logical volumes. The catalog information manages the dataset stored in the logical volume. The resident management program automatically acquires a logical volume name from a dataset name specified by a user with reference to the catalog information and has the dataset on the logical volume having the corresponding logical volume name to be resident. The disk array system has a microprogram (control means) which receives the instruction to set residence from the resident management program so as to make the dataset on the logical volume having the corresponding logical volume name resident in the cache memory. In this manner, the resident management program automatically acquires the logical volume name from the specified dataset name by using the catalog information, thereby enabling the dataset to be resident in the cache memory using only the dataset name.

The resident management program has a function to automatically acquire a logical volume name of the dataset name specified by the user with reference to the catalog information and instruct the release of an unused resident area for a logical volume having the corresponding logical volume name. Also, the microprogram has a function to receive the instruction to release residence from the resident management program so as to delete the unused resident area for the logical volume having the corresponding logical volume name from the cache memory. In this manner, the resident management program stores an operation log or configuration information in a dedicated dataset, acquires previous operation contents from the dedicated dataset when starting the program, and when the dataset is moved, deletes a resident area of the dataset so as to make the specified dataset resident.

### <Entire Configuration of Information Processing System>

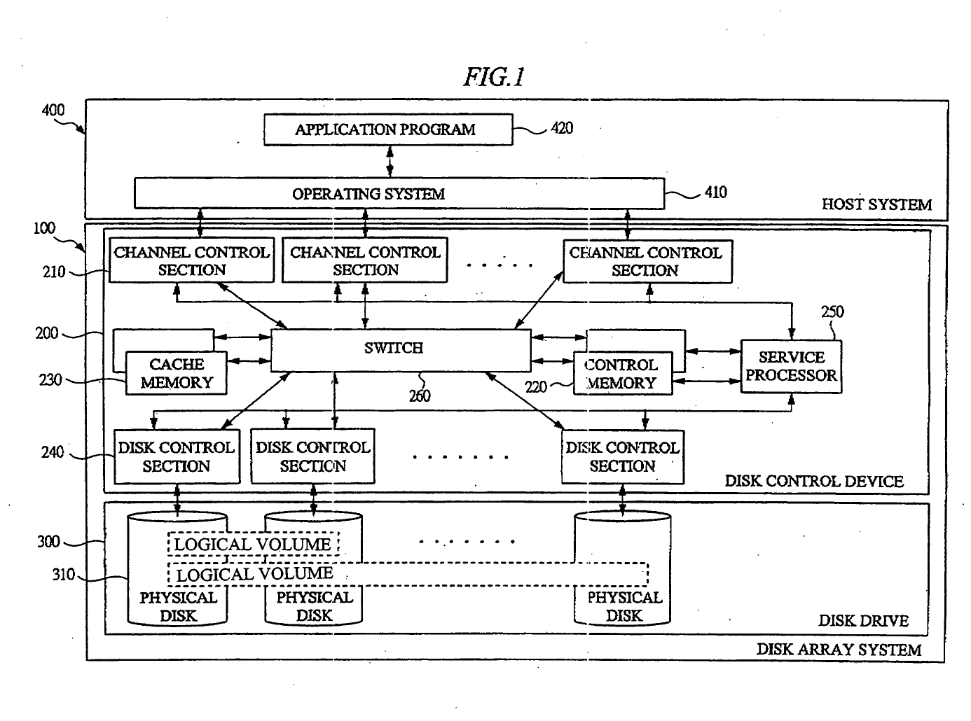

An example of the entire configuration of the information processing system according to an embodiment of the present invention will be described with reference to FIG. 1. FIG. 1 is a diagram illustrating the entire configuration of the information processing system according to this embodiment.

The information processing system of this embodiment is comprised of a disk array system 100 and a host system 400.

The disk array system 100 has a disk control device 200 and a disk drive 300. For example, the disk control device 200 controls the disk drive 300 according to a command received from the host system 400. The disk control device 200, for example, receives a data input/output request from the host system 400 and reads/writes data stored in a physical disk 310 in the disk drive 300. The disk control device 200 receives various commands for managing the disk array system 100 from, for example, a management client system (not shown) so as to perform various settings of the disk array system 100.

The host system 400 is a piece of information equipment such as a computer having a CPU and a memory. The CPU in the host system 400 executes various programs so that various functions are performed. The host system 400 (for example a mainframe computer) is provided with an operating system 410 and an application program 420. Besides a mainframe computer, a workstation, a personal computer or the like can be used as the host system 400.

The host system 400 is connected directly to the disk control device 200 without a network so as to be communicable with the disk control device 200. The communication between the host system 400 and the disk control device 200 is executed according to communication protocols such as FICON (Fibre Connection) (registered trademark), ESCON (Enterprise System Connection) (registered trademark), ACONARC (Advanced Connection Architecture) (registered trademark), and FIBARC (Fibre Connection Architecture) (registered trademark). A data access request for each block is transmitted from the host system 400 to the disk array system 100 according to the communication protocols.

Note that the host system 400 can be connected to the disk control device 200 via not only the above communication protocols but also, for example LAN (Local Area Network). When connected via LAN, the communication can be made according to, for example, TCP/IP (Transmission Control Protocol/Internet Protocol).

### <Disk Drive>

The disk drive 300 has a lot of physical disks 310. Hence, a large-capacity storage area can be provided to the host system 400. The physical disk 310 can be comprised of a data storage medium such as a hard disk drive or a plurality of hard disk drives constituting RAID (Redundant Arrays of Inexpensive Disks). Further, a logical volume which is a logical storage area can be set as a physical storage area provided by the physical disks 310.

The disk control device 200 can be connected to the disk drive 300 directly as shown in FIG. 1, or can be connected via a network. Further, the disk drive 300 can be formed integrally with the disk control device 200.

### <Disk Control Device>

The disk control device 200 has channel control sections 210, a control memory 220, a cache memory 230, disk control sections 240, a service processor 250, and a switch 260. The disk control device 200 communicates with the host system 400 via the channel control sections 210.

The channel control section 210 has a communication interface for communication with the host system 400 and has a function to transmit and receive a data input/output command or the like to/from the host system 400.

The channel control sections 210 as well as the service processor 250 are connected to each other via an internal LAN. Therefore, it is possible to transmit and install a microprogram or the like to be executed by the channel control section 210 from the service processor 250.

The switch 260 mutually connects the channel control sections 210, the control memory 220, the cache memory 230, the disk control sections 240 and the service processor 250. Data and commands are transmitted/received among the channel control sections 210, the control memory 220, the cache memory 230, the disk control sections 240 and the service processor 250 via the switch 260. The switch 260 is comprised of, for example, a cross bus switch.

The control memory 220 and the cache memory 230 are storage memories which are shared by the channel control sections 210 and the disk control sections 240. The control memory 220 is used mainly for storing control information and commands, whereas the cache memory 230 is used mainly for storing data. Further, in the cache memory 230, information can be resident or the resident information can be released. This is detailed later.

For example, in the case where the data input/output request received by the channel control section 210 from the host system 400 is a writing command, the channel control section 210 writes the writing command into the control memory 220. At the same time, the channel control section 210 writes writing data received from the host system 400 into the cache memory 230. On the other hand, the disk control section 240 monitors the control memory 220, and when detecting that the writing command is written into the control memory 220, the disk control section 240 reads the writing data from the cache memory 230 according to the command and writes it into the physical disk 310 in the disk drive 300.

In addition, in the case where the data input/output request received by the channel control section 210 from the host system 400 is a reading command, the channel control section 210 checks whether data to be read is present in the cache memory 230. When the data is present in the cache memory 230, the channel control section 210 transmits the data to the host system 400. On the other hand, in the case where the data to be read is not present in the cache memory 230, the channel control section 210 writes the reading command into the control memory 220 and monitors the control memory 220. The disk control section 240, which detects that the reading command is written into the control memory 220, reads the data to be read from the physical disk 310 in the disk drive 300 and writes it into the cache memory 230, and at the same time, writes this writing of the data into the control memory 220. When the channel control section 210 detects that the data to be read is written into the cache memory 230, the data is transmitted to the host system 400.

As described above, the data is transmitted/received between the channel control section 210 and the disk control section 240 via the cache memory 230. From among the data stored in the physical disk 310, the data read or written by the channel control section 210 and the disk control section 240 is temporarily stored in the cache memory 230.

Note that, in addition to the configuration in which the channel control section 210 executes an instruction for writing or reading data to or from the disk control section 240 indirectly via the control memory 220, the configuration in which the channel control section 210 directly executes the instruction for writing or reading data to or from the disk control section 240 without the control memory 220 is also available. Further, it is possible to provide the channel control section 210 with the function of the disk control section 240 so as to be a data input/output control section.

The disk control sections 240 are connected to the plural physical disks 310 for storing data so as to be communicable and control the disk drive 300. For example, as described above, the channel control section 210 reads/writes data from/into the physical disk 310 according to the data input/output request received form the host system 400.

The disk control sections 240 as well as the service processor 250 are connected to each other via an internal LAN, so as to be communicable with one another. Therefore, it is possible to transmit and install the microprogram or the like to be executed by the disk control sections 240 from the service processor 250.

This embodiment has described the case where the control memory 220 and the cache memory 230 are provided independently from the channel control sections 210 and the disk control sections 240. However, the present invention is not limited to this, and it is preferable that the control memory 220 and the cache memory 230 are separately provided in each of the channel control sections 210 and the disk control sections 240. In this case, the switch 260 mutually connects the channel control sections 210 and the disk control sections 240 having the separated control memories 220 or cache memories 230.

Further, at least any of the channel control sections 210, the disk control sections 240, the switch 260, the control memories 220 and the cache memories 230 can be formed integrally.

The service processor 250 is a computer for maintaining/managing the disk array system 100. An operator operates the service processor 250 so as to set the configuration of the physical disks 310 in the disk drive 300, set a path as a communication path among the host system 400, a management client system and the channel control sections 210, set a logical volume, install the microprogram to be executed by the channel control sections 210 and the disk control sections 240, and the like. As the setting of the configuration of the physical disks 310 in the disk drive 300, for example, the number of physical disks 310 is increased or decreased, or the RAID configuration is changed (change from RAID1 to RAID5 or the like).

Further, the service processor 250 can check an operational state of the disk array system 100 and specify a defective portion, and install an operating system to be executed by the channel control section 210. These setting and control can be executed by an operator using a user interface provided with the service processor 250 or a user interface of the management client system for displaying a WEB page provided by a Web server operated by the service processor 250. Also, the operator can set the targets and contents of monitoring faults and set the fault notification destination by operating the service processor 250.

The service processor 250 can be included in the disk control device 200 or can be installed externally. Further, both a computer which is exclusive for maintaining and managing the disk control device 200 and the disk drive 300 and a general purpose computer having the maintenance/management function are available as the service processor 250.

### <Cooperative Configuration Between Residence in the Cache Memory and Load Balance>

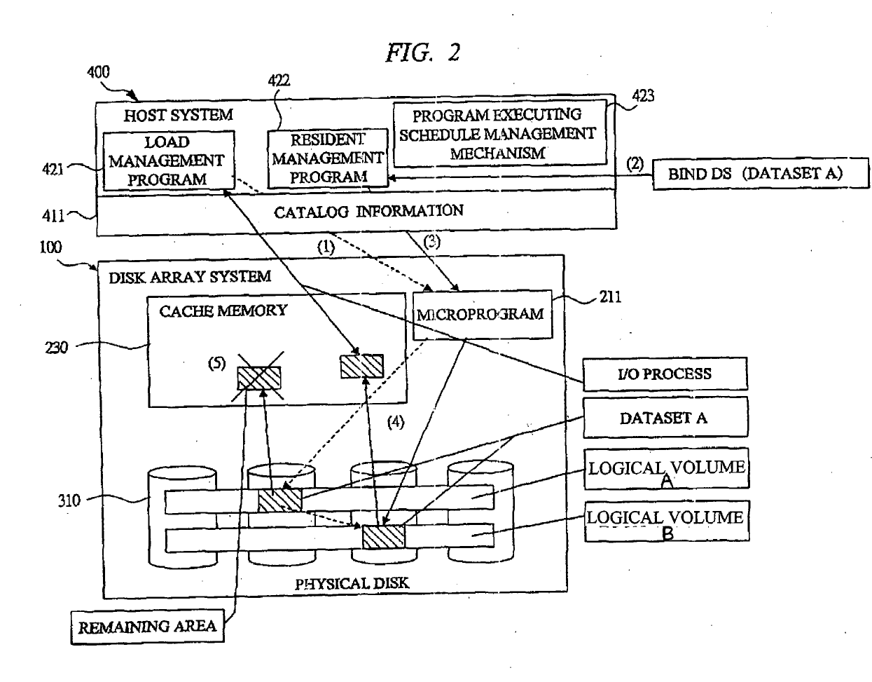

An example of the cooperative configuration between the residence in the cache memory and the load balance in the information processing system according to this embodiment will be described with reference to FIG. 2. FIG. 2 is a diagram illustrating the cooperative configuration between the residence in the cache memory and the load balance.

As to the information processing system according to this embodiment, its entire configuration and functions of the components are as detailed based on FIG. 1, but the cooperative configuration between the residence in the cache memory and the load balance which is the characteristic of the present invention is as follows.

That is to say, the host system 400 has a load management program 421, catalog information 411, and a resident management program 422. The load management program 421 distributes the dataset to be stored in the physical disk 310 to the logical volumes. The catalog information 411 manages the dataset stored in the logical volume. The resident management program 422 automatically acquires a logical volume name based on a dataset name specified by a user with reference to the catalog information 411 and instructs the dataset on the logical volume having the corresponding logical volume name to be resident, and also, it automatically acquires a logical volume name of a dataset name specified by the user with reference to the catalog information 411 and instructs release of an unused resident area for the logical volume having the corresponding logical volume name. The load management program 421 and the resident management program 422 are provided as application programs 420. Further, the catalog information 411 is provided as a management table in the operating system 410.

The disk array system 100 is provided with the physical disks 310, the cache memory 230 and the microprogram 211. The physical disk 310 is comprised of a plurality of the logical volumes for storing datasets thereinto. The cache memory 230 temporarily stores the dataset which is written and read into/from the physical disk 310 therein. The microprogram 211 makes the dataset on the logical volume having the corresponding logical volume name resident in the cache memory 230 in accordance with the instruction to set residence from the resident management program 422 and deletes the unused resident area for the logical volume having the corresponding logical volume name from the cache memory 230 in accordance with the instruction to release residence from the resident management program 422. The microprogram 211 is provided in the channel control section 210.

In such a configuration, in the control of the information in the cache memory 230, the logical volume name is automatically acquired based on the dataset name specified by the user with reference to the catalog information 411, and thus, the dataset on the logical volume having the corresponding logical volume name can be resident in the cache memory 230. Further, in the control of the release of the resident information in the cache memory 230, the logical volume name of the dataset name specified by the user is automatically acquired with reference to the catalog information 411, and thus, the unused resident area for the logical volume having the corresponding logical volume name can be deleted from the cache memory 230.

### <Configuration of Catalog Information>

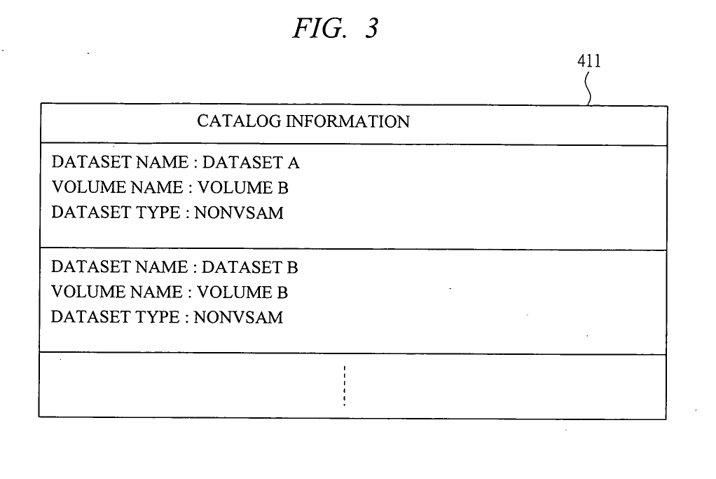

An example of the configuration of the catalog information in the information processing system according to this embodiment will be described with reference to FIG. 3. FIG. 3 is a diagram illustrating the configuration of the catalog information.

As shown in FIG. 3, the catalog information 411 is prepared as a management table for each dataset, and it stores the information of the dataset names, the logical volume names, and the dataset types. The dataset is a file comprised of a plurality of data. The logical volume is a logical storage area.

For example, in the example of FIG. 3, a dataset A is stored in a logical volume B and its type is a sequential configuration dataset/file (NONVSAM). Further, a dataset B is stored in a logical volume B and its type is a sequential configuration dataset/file (NONVSAM).

### <Configuration of Logical Volume>

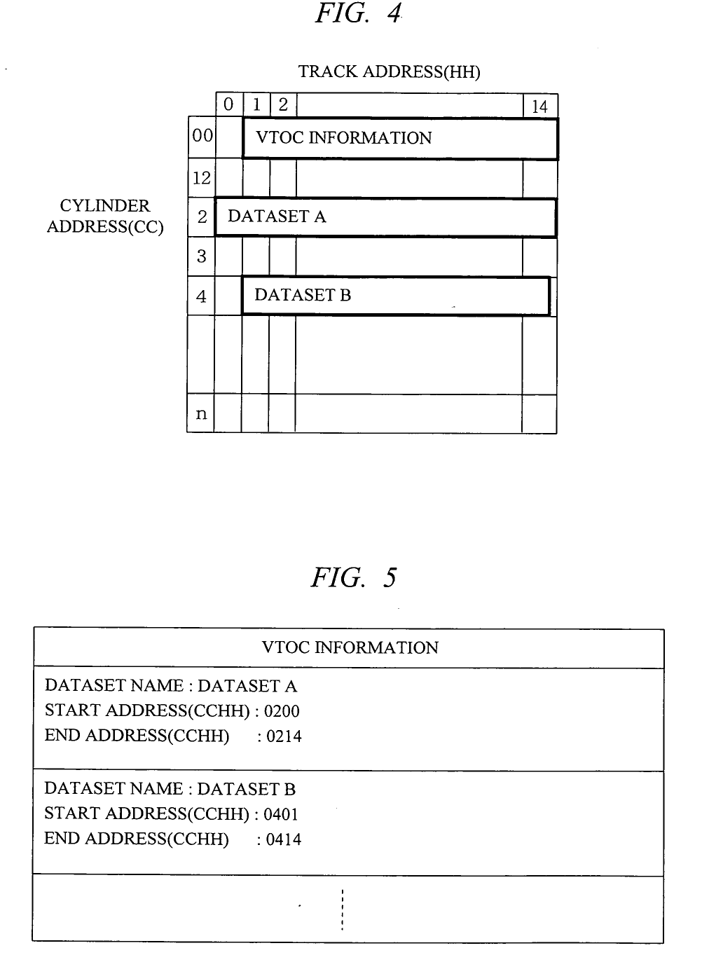

An example of the configuration of the logical volume in the information processing system according to this embodiment will be described with reference to FIGS. 4 and 5. FIG. 4 is a diagram illustrating the configuration of the position information of the logical volume. FIG. 5 is a diagram illustrating the configuration of volume inventory information.

As shown in FIG. 4, the logical volume stores volume inventory (VTOC: Volume Table of Contents) information and dataset information therein. Position information of the logical volume is expressed two-dimensionally by a cylinder address (CC) and a track address (HH), and positions of the VTOC information and the dataset information are managed by CCHH.

For example, in the example in FIG. 4, the VTOC information is stored at a position of CCHH: 0001-0014, the dataset A is stored at a position of CCHH: 0200-0214, and the dataset B is stored at a position of CCHH: 0401-0414.

As shown in FIG. 5, the VTOC information is prepared as a management table per dataset, and it stores dataset names and information of start addresses (CCHH) and end addresses (CCHH) of the positions of the logical volume in which the datasets are stored.

For example, in the example of FIG. 5, the dataset A is stored at the position from a start address of CCHH: 0200 to an end address of CCHH: 0214 and the dataset B is stored at the position from a start address of CCHH: 0401 to an end address of CCHH: 0414.

### <Operation to Set and Release Residence in Cache Memory>

An example of the operation to set and release residence information in the cache memory in the information processing system according to this embodiment will be described with reference to FIG. 2. In FIG. 2, operation routes and the corresponding description of the operations are denoted by the same reference numerals.

(1) The load management program 421 in the host system 400 moves the dataset A from the logical volume A to the logical volume B with reference to the catalog information 411. The operation by the load management program 421 is for moving the dataset A from the logical volume A whose frequency of use is high to the logical volume B whose frequency of use is low in order to set an appropriate load balance for improving the input/output performance.

Concretely, the dataset A is moved by the microprogram 211 in the disk array system 100 based on an instruction from the load management program 421. First, the load management program 421 secures an area in the logical volume B for storing the dataset A therein and reads the dataset A from the logical volume A so as to write the dataset A into the secured area in the logical volume B. By doing so, the movement from the logical volume A to the logical volume B is done.

(2) Thereafter, the resident management program 422 in the host system 400 makes the dataset A resident in the cache memory 230. At this time, the resident management program 422 receives the instruction to set residence of the dataset name (dataset A) from the user. At this time, the specification of the logical volume name is not necessary.

A time zone in which the load management program 421 moves the dataset A is irregular. For this reason, the timing at which the resident management program 422 is executed does not become clear. In order to solve this problem, two methods are provided. In one method, the resident management program 422 is registered in a program executing schedule management mechanism 423 on the host system 400 so as to be actuated periodically (for example, it is actuated once a day). In the other method, the program executing schedule management mechanism 423 monitors a message which is output after the load management program 421 is executed, and the resident management program 422 is registered so as to be executed when a specified message is detected. There is a time difference between the time at which the dataset A is moved and the time at which the dataset A is resident in the cache memory, but in any of the methods, after the dataset A is moved, it is resident in the cache memory.

(3) Then, the resident management program 422 acquires the logical volume B in which the dataset A is stored from the catalog information 411. Further, the resident management program 422 acquires position information (CCHH) of the dataset A from the VTOC information on the acquired logical volume B. In FIG. 4, the position information about the dataset A includes the start address: CC=02 and HH=00, and the end address: CC=02 and HH=14.

Thereafter, the resident management program 422 adds the position information about the dataset A as a parameter to a resident instruction command to the cache memory 230 and issues the command to the logical volume B in the disk array system 100. Concretely, the resident instruction command is issued to the microprogram 211 in the disk array system 100.

(4) Subsequently, the microprogram 211 in the disk array system 100, which receives the resident instruction command to the cache memory 230, makes the dataset A of the specified position information on the logical volume B resident in the cache memory 230 according to the parameter of the command.

(5) At this time, in the case where the resident area is present in the logical volume A where the dataset A is previously resident, the resident management program 422 issues a command for deleting an unused resident area to the logical volume A before the instruction to set residence is given to the cache memory 230.

In order to determine the unused area, the VTOC information of the logical volume A and the information of the resident area of the logical volume A into the cache memory 230 are acquired and the exclusive OR of both the information is obtained. Then, the resident area where a dataset is not present is determined and the release of residence in the area is instructed.

Further, in order to recognize the logical volume A, an operation log executed by the resident management program 422 is stored into a dedicated dataset so as to discriminate a target logical volume based on the operation log. Alternatively, all target logical volumes for the resident management program 422 are specified by a user in advance.

In such a manner, the user can set residence in the cache memory 230 without regard to the logical volume in which the dataset is present. Further, an unused resident area in the cache memory 230 can be automatically deleted.

<Command Processing Sequence of Instruction to Set Residence into Cache Memory>

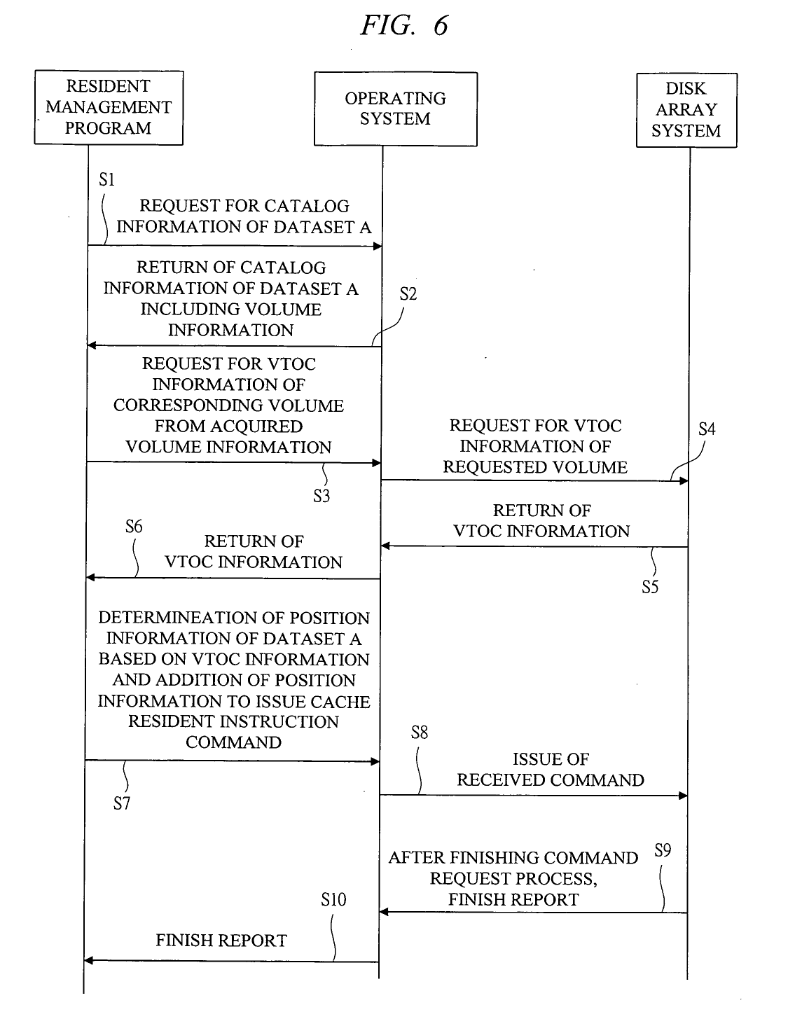

An example of the command processing sequence of the instruction to set residence into the cache memory in the information processing system according to this embodiment will be described with reference to FIG. 6. FIG. 6 is a diagram illustrating the command processing sequence of the instruction to set residence into the cache memory.

First, in the host system 400, the resident management program 422 requests the operating system 410 to transmit the catalog information 411 of the dataset A (S1). In response to the request, the operating system 410 returns the catalog information 411 of the dataset A including the information of the logical volume to the resident management program 422 (S2).

Subsequently, the resident management program 422 requests the operating system 410 to transmit the VTOC information of the corresponding logical volume from the acquired information of the logical volume (S3). In response to the request, the operating system 410 requests the disk array system 100 to transmit the requested VTOC information of the logical volume (S4).

Further, in response to the request of the VTOC information of the logical volume, the disk array system 100 returns the VTOC information to the operating system 410 (S5). In response to this, the operating system 410 transmits the VTOC information to the resident management program 422 (S6).

Subsequently, the resident management program 422 determines the position information about the dataset A from the VTOC information and issues the resident instruction command with the position information to the cache memory 230 to the operating system 410 (S7). In response to the command, the operating system 410 issues the received command to the disk array system 100 (S8).

In response to the issue of the command, when the process of the command request is finished, the disk array system 100 reports the finish of the process to the operating system 410 (S9). In response to the report, the operating system 410 reports the finish to the resident management program 422 (S10).

In such a manner, the resident instruction command for the dataset to the cache memory 230 can be issued. Note that the command processing sequence of the instruction to release residence is similar to this.

<Instruction Format to Set and Release Residence from User>

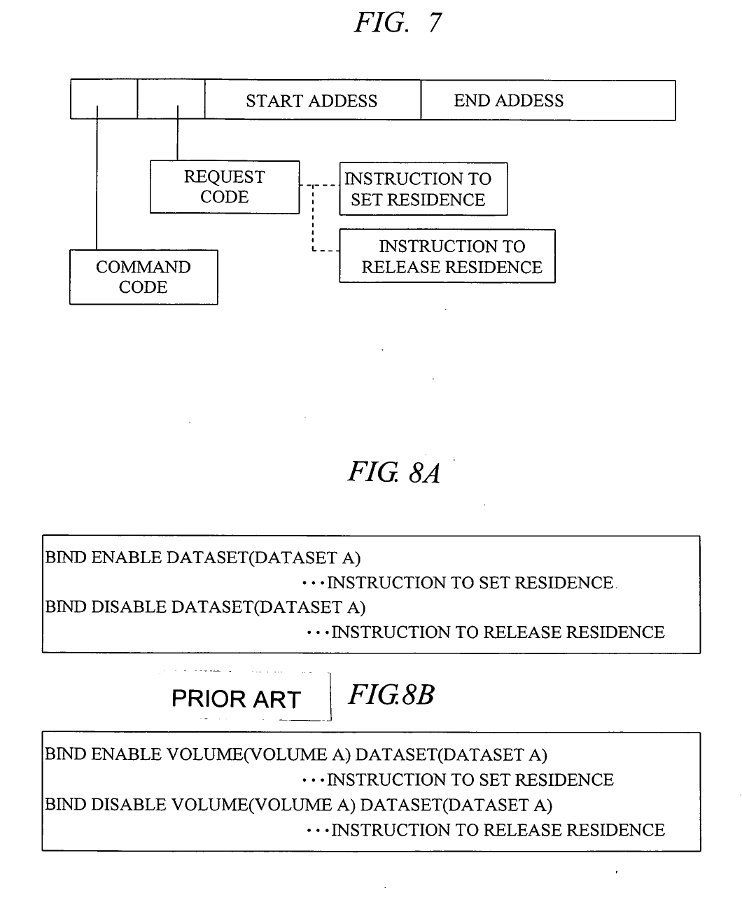

An example of the instruction format to set and release residence from the user in the information processing system according to this embodiment will be described with reference to FIGS. 7 and 8. FIG. 7 is a diagram illustrating a command format. FIG. 8A is a diagram illustrating an example of the instruction format to set and release residence in the present invention, and FIG. 8B is a diagram illustrating an example in the conventional art (Japanese Patent Application Laid-Open No. 2002-132552).

As shown in FIG. 7, the command format from the user is comprised of information of a command code, a request code, a start address and an end address, and the instruction to set residence and the instruction to release residence are discriminated by the request code.

As shown in FIG. 8A, in the instruction formats to set and release residence according to the present invention, “ENABLE” is specified as the request code in the case of the instruction to set residence, and “DISABLE” is specified as the request code in the case of the instruction to release residence with using the command code BIND. Then, “DATASET” (dataset A) having the dataset name to be the target to set residence or release residence is specified.

On the contrary, as shown in FIG. 8B, in the instruction format to set and release residence in the conventional art, it is necessary to specify both of the name of the dataset target to set residence or release residence and the VOLUME (logical volume A) having the name of the logical volume in which the dataset is stored.

As described above, in the conventional art, it is necessary to specify the logical volume name as well as the dataset name, but in the present invention, the instruction to set residence and the instruction to release residence can be executed by specifying only the dataset name.

Note that in the case where the user instructs to set residence and release residence without being cooperative with the catalog information 411 of the present invention like in the conventional art, a logical volume searching application program for automatically searching a logical volume name of a dataset to be resident in the cache memory 230 is executed so as to find the logical volume in which the dataset is present, and then, an application program having the function to instruct to set residence and release residence is executed to specify the found logical volume name and the dataset name. In this manner, the residence and the release of residence become possible.

### <Deletion of Remaining Area Due to Release of Residence>

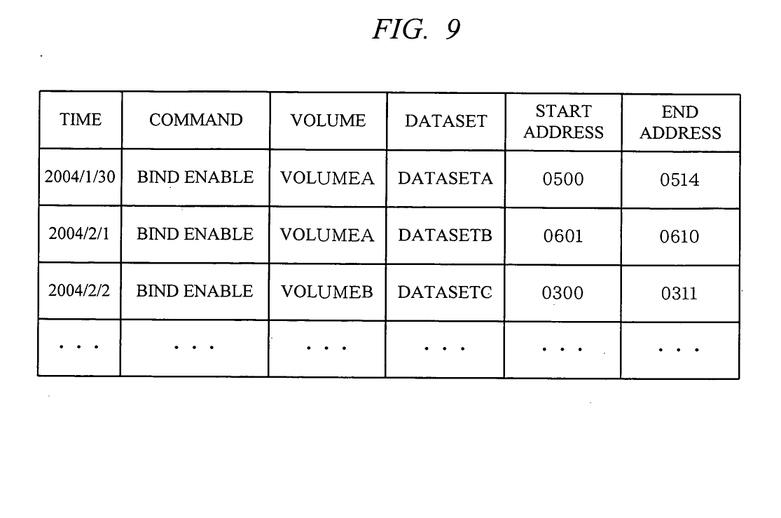

An example of deletion of a remaining area due to the release of residence in the information processing system according to the embodiment will be described with reference to FIG. 9. FIG. 9 is a diagram illustrating a format of a dataset where histories are stored (first method).

In the first method, the format of the dataset where the histories are stored is comprised of information about time (year/month/day), a command, a logical volume, a dataset, a start address and an end address. Histories are stored by the resident management program 422 every time when the instruction to set residence is executed.

For example in the example of FIG. 9, the dataset A (DATASETA) on the logical volume A (VOLUMEA) is instructed to be resident in an address of 0500 to 0514 on Jan. 30, 2004. Similarly, DATASETB on VOLUMEA is instructed to be resident in an address of 0601 to 0610 on Feb. 1, 2004, and DATASETC on VOLUMEB is instructed to be resident in an address of 0300 to 0311 on Feb. 2, 2004.

In the deletion of a remaining area due to the release of residence, when a dataset is instructed to be resident in the cache memory 230, the resident management program 422 determines whether the same dataset is instructed to be resident in the past with reference to the dataset including this history. When the same dataset is instructed to be resident, the past resident dataset is released, and then, the latest dataset is made to be resident. As a result, the remaining resident area in the cache memory 230 of the dataset moved by the load balance function of the load management program 421 can be deleted appropriately.

In a second method, the user specifies all target logical volumes from the resident management program 422 in advance, and after the past resident dataset is released, the latest dataset is made resident. In this manner, similar to the first method, the remaining resident area in the cache memory 230 can be deleted appropriately.

In the foregoing, the invention made by the inventors of the present invention has been concretely described based on the embodiment. However, it is needless to say that the present invention is not limited to the foregoing embodiment and various modifications and alterations can be made within the scope of the present invention.

What is claimed is:

1. An information processing system, comprising:
an external storage device having a plurality of logical volumes comprised of a plurality of physical disks for storing datasets therein and a cache memory for temporarily storing datasets to be written and read into/from said logical volumes; and
a host system which is connected to said external storage device and writes and reads the datasets into/from said external storage device,
wherein said host system has load management means for moving per dataset one dataset stored in one of the logical volumes to another one of the logical volumes whose frequency of use is lower than said one logical volume, management information for managing per dataset datasets stored or moved in logical volumes of said external storage device, and resident management means for automatically acquiring a logical volume name in response to a dataset residence setting or releasing instruction from a user, which includes a dataset name specified by the user and excludes the logical volume name therefrom, with reference to said management information thereby instructing a dataset with the specified dataset name and stored on the logical volume having the corresponding logical volume name to be resident in or to be deleted from the cache memory, said acquired logical volume name being different from the dataset name specified by the user and never being forwarded to the user, and
said external storage device has control means for receiving an instruction to set residence from said resident management means to make said dataset with the specified dataset name and stored on the logical volume having the corresponding logical volume name resident in the cache memory.

2. The information processing system according to claim 1, wherein said resident management means, in response to the dataset residence setting or releasing instruction from the user, further acquires physical cylinder and track position information of the dataset from volume inventory information based upon said acquired logical volume name to generate a command to instruct the cache memory to make said dataset with the specified dataset name resident in the cache memory.

3. A control method for an information processing system, said information reprocessing system comprising: an external storage device having a plurality of logical volumes comprised of a plurality of physical disks for storing datasets therein and a cache memory for temporarily storing datasets to be written and read into/from said logical volumes; and a host system which is connected to said external storage device and writes and reads the dataset into/from said external storage device, said method comprising:
moving per dataset one dataset stored in one of the logical volumes to another one of the logical volumes whose frequency of use is lower than said one logical volume by means of a load management means of said host system;
recording management information for managing per dataset datasets stored or moved in logical volumes of said external storage device;
automatically acquiring a logical volume name in response to a dataset residence setting or releasing instruction from a user, which includes a dataset name specified by the user and excludes the logical volume name therefrom, with reference to said management information thereby instructing a dataset with the specified dataset name and stored on the logical volume having the corresponding logical volume name to be resident in the cache memory by means of a resident management means of said host system, said acquired logical volume name being different from the dataset name specified by the user and never being forwarded to the user; and
receiving an instruction to set residence from said resident management means to make said dataset with the specified dataset name and stored on the logical volume having the corresponding logical volume name resident in the cache memory by means of control means of said external storage device.

4. The control method for the information processing system according to claim 3, wherein said resident management means, in response to the dataset residence setting or releasing instruction from the user, further acquires physical cylinder and track position information of the dataset from volume inventory information based upon said acquired logical volume name to generate a command to instruct the cache memory to make said dataset with the specified dataset name resident in the cache memory.
